(19) United States
(12) Patent Application Publication
(10) Pub. No.: US 2015/0204607 A1
(43) Pub. Date: Jul. 23, 2015

(54) DESICCANT CONTAINER WITH MOISTURE INDICATING ABILITY

(71) Applicant: OK BIOTECH CO. LTD., HSINCHU CITY (TW)

(72) Inventors: CHIA-TE LAI, Hsinchu City (TW); AN-YUAN LEE, Hsinchu City (TW)

(73) Assignee: OK BIOTECH CO. LTD., HSINCHU CITY (TW)

(21) Appl. No.: 14/208,533

(22) Filed: Mar. 13, 2014

(30) Foreign Application Priority Data
Jan. 21, 2014 (TW) 103201233

(51) Int. Cl. F26B 21/08; B01L 1/02; B01D 53/26

(52) U.S. Cl. CPC F26B 21/083; B01D 53/261; B01L 1/025

(57) ABSTRACT

A desiccant container with moisture indicating ability is disclosed, which is used for storing biological test pieces and is formed with at least one peeping window to be used for observing a humidity display unit embedded inside the drying container so as to determine whether the biological test pieces inside the drying container had already been exposed to moisture and become damp according to the reading on the humidity display unit.

### FIELD OF THE INVENTION

The present invention relates to a desiccant container with moisture indicating ability, and more particularly, to a desiccant container for storing biological test pieces that is configured with a peeping window.

### BACKGROUND OF THE INVENTION

It is a common problem that the biological test piece is exposed to moisture and become damp, and consequently, the damped biological test piece which is used for placing a biological sample and carrying out detection and signal reading by a detection host machine can not perform normally for enabling the detection host machine to acquire an accurate test result from the biological sample. Therefore, it is common to store the biological test pieces that are available on the market in a drying container for help the biological test pieces to stay dry. Generally, the drying container can be an airtight structure that can be vacuumed, or is simply a can having a drying agent disposed therein, whichever can help the biological test pieces to stay dry.

Generally, drying containers are made of opaque plastic materials, and thus, operationally, it is unable to know before opening the drying container whether or not the biological test pieces stored therein had been exposed to moisture and become damp. Consequently, a user can perform a bio test using a biological test piece without knowing whether the biological test piece is preserved in good quality or not, and thus the user has no way to guarantee that the test result from the detection host machine is accurate. Therefore, any diagnosis based upon the test result may be erroneous. Moreover, for a consumer who is shopping for a container of biological test pieces, it would be very helpful if there is a way for allowing he/she to know the perservation condition of the biological test pieces in every container on the shelf, so that the user can easily select the one containr with best quality. On the other hand, by the same way, the shop owner also can easily inspect every container of biological test pieces on the shelf at any time, and thus is able to take those containers containing porblematic biological test pieces off shelf just in time for goodwill.

### SUMMARY OF THE INVENTION

The primary object of the present invention is to provide a desiccant container with moisture indicating ability, which is formed with at least one transparent area, to be used for allowing a plurality of desiccant granules stored inside the desiccant container to become observable, and thus, to determine whether the biological test pieced stored inside the desiccant container had already been exposed to moisture and become damp according to the color changing of the plural desiccant granules.

Moreover, the desiccant granules in the present invention can be made of water glass, which is a soluble alkali-sodium silicate material and is characterized in that: it is blue in color when dry and will be turn into red after absorbing moisture.

To achieve the above object, in an embodiment, the present invention provides a desiccant container with moisture indicating ability, comprising: an outer canister, formed with a cavity and having a cap connected thereto; an inner canister, disposed inside the cavity of the outer canister while allowing a hollow compartment insulation to be formed between the bottom of the inner canister and the bottom of the outer canister, and being formed with a chamber and a plurality of holes in a manner that the chamber is used for storing a plurality of biological test pieces and the plural holes are formed at the bottom of the inner container; and a plurality of desiccant granules, disposed inside the hollow compartment insulation for allowing the same to absorb moisture and change color consequently; wherein, the outer canister is made of an opaque material while the inner canister is made of a transparent material, and thereby, the color changing of the plural desiccant granules inside the hollow compartment insulation is observable when the cap of the first outer canister is opened.

In another embodiment, the present invention provides a desiccant container with moisture indicating ability, comprising: an outer canister, formed with a cavity and having a cap connected thereto; an inner canister, disposed inside the cavity of the outer canister while allowing a hollow compartment insulation to be formed between the bottom of the inner canister and the bottom of the outer canister, and being formed with a chamber and a plurality of holes in a manner that the chamber is used for storing a plurality of biological test pieces and the plural holes are formed at the bottom of the inner container; and a plurality of desiccant granules, disposed inside the hollow compartment insulation for allowing the same to absorb moisture and change color consequently; wherein, the outer canister is made of a transparent material while the inner canister is made of an opaque material, and thereby, the color changing of the plural desiccant granules inside the hollow compartment insulation is observable.

In further another embodiment, the present invention provides a desiccant container with moisture indicating ability, comprising: an outer canister, formed with a cavity and having a cap connected thereto; an inner canister, disposed inside the cavity of the outer canister while allowing a hollow compartment insulation to be formed between the bottom of the inner canister and the bottom of the outer canister, and being formed with a chamber and a plurality of holes in a manner that the chamber is used for storing a plurality of biological test pieces and the plural holes are formed at the bottom of the inner container; and a plurality of desiccant granules, disposed inside the hollow compartment insulation for allowing the same to absorb moisture and change color consequently; wherein, the outer canister is made of an opaque material and is formed with a transparent area at the bottom of the outer canister at a position corresponding to the hollow compartment insulation, while the inner canister is made of a material selected from the group consisting of: an opaque material and a transparent material, and thereby, the color changing of the plural desiccant granules inside the hollow compartment insulation is observable.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is a three-dimensional view of a desiccant container with moisture indicating ability of the present invention.

FIG. 2 is an exploded view of a desiccant container with moisture indicating ability of the present invention.

FIG. 3 is a schematic diagram showing a desiccant container with moisture indicating ability according to a first embodiment of the present invention.

FIG. 4 is a schematic diagram showing a desiccant container with moisture indicating ability according to a second embodiment of the present invention.

FIG. 5 is a schematic diagram showing a desiccant container with moisture indicating ability according to a third embodiment of the present invention.

### DESCRIPTION OF THE EXEMPLARY EMBODIMENTS

For your esteemed members of reviewing committee to further understand and recognize the fulfilled functions and structural characteristics of the invention, several exemplary embodiments cooperating with detailed description are presented as the follows.

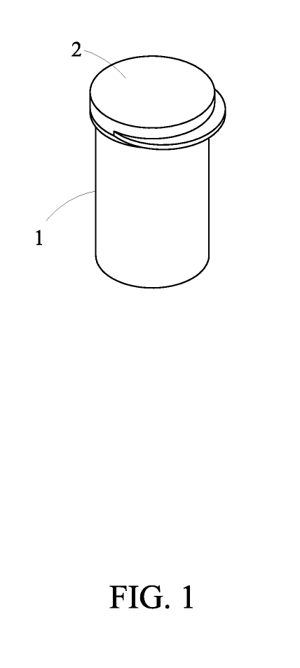

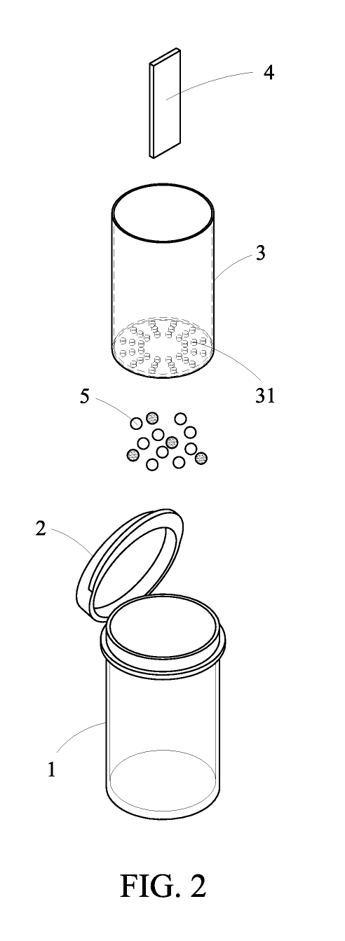

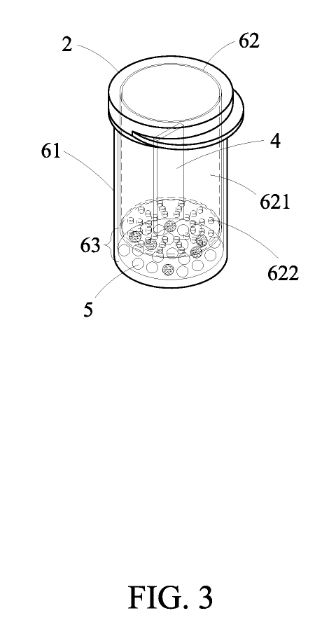

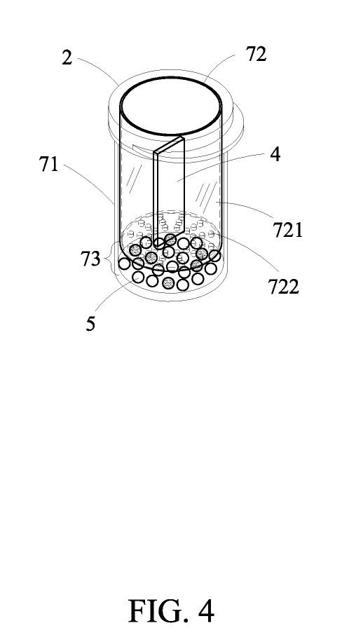

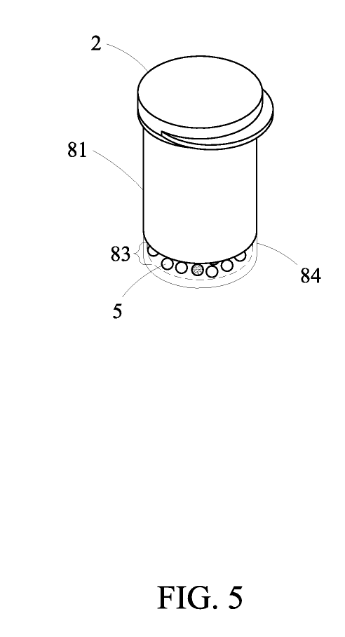

Please refer to FIG. 1 and FIG. 2, which are a three-dimensional view and an exploded view of a desiccant container with moisture indicating ability of the present invention. As shown in FIG. 1 and FIG. 2, the disclosed desiccant container has an outer canister 1, which is connected to a cap 2 and has a plurality of desiccant granules 5 placed on the bottom thereof. The outer canister 1 is designed for receiving an inner canister 3, which is formed with a plurality of holes 31 formed at the bottom thereof and is provided for storing a plurality of biological test pieces 4. Nevertheless, the present invention provides three exemplary desiccant containers, which are shown respectively in FIG. 3, FIG. 4 and FIG. 5.

Please refer to FIG. 3, which is a schematic diagram showing a desiccant container with moisture indicating ability according to a first embodiment of the present invention. The desiccant container with moisture indicating ability according of the first embodiment comprises: a first outer canister 61, formed with a cavity and having a cap 2 connected thereto; a first inner canister 62, disposed inside the cavity of the first outer canister 61 while allowing a hollow compartment insulation 63 to be formed between the bottom of the first inner canister 62 and the bottom of the first outer canister 61, and being formed with a chamber 621 and a plurality of holes 622 in a manner that the chamber 621 is used for storing a plurality of biological test pieces 4 and the plural holes 622 are formed at the bottom of the first inner container 62; and a plurality of desiccant granules 5, disposed inside the hollow compartment insulation 63 for allowing the same to absorb moisture and change color consequently;

wherein, the first outer canister 61 is made of an opaque material while the first inner canister 62 is made of a transparent material, and thereby, the color changing of the plural desiccant granules 5 inside the hollow compartment insulation 63 is observable when the cap 2 of the first outer canister 61 is opened.

Please refer to FIG. 4, which is a schematic diagram showing a desiccant container with moisture indicating ability according to a second embodiment of the present invention. The desiccant container with moisture indicating ability according of the second embodiment comprises: a second outer canister 71, formed with a cavity and having a cap 2 connected thereto; a second inner canister 72, disposed inside the cavity of the second outer canister 71 while allowing a hollow compartment insulation 73 to be formed between the bottom of the second inner canister 72 and the bottom of the second outer canister 71, and being formed with a chamber 721 and a plurality of holes 722 in a manner that the chamber 721 is used for storing a plurality of biological test pieces 4 and the plural holes 722 are formed at the bottom of the second inner container 72; and a plurality of desiccant granules 5, disposed inside the hollow compartment insulation 73 for allowing the same to absorb moisture and change color consequently; wherein, the second outer canister 71 is made of a transparent material while the second inner canister 72 is made of an opaque material, and thereby, the color changing of the plural desiccant granules 5 inside the hollow compartment insulation 73 is observable.

Please refer to FIG. 5, which is a schematic diagram showing a desiccant container with moisture indicating ability according to a third embodiment of the present invention. The desiccant container with moisture indicating ability according of the third embodiment comprises: a third outer canister 81, formed with a cavity and having a cap 2 connected thereto; a third inner canister 82, disposed inside the cavity of the third outer canister 81 while allowing a hollow compartment insulation 83 to be formed between the bottom of the third inner canister 82 and the bottom of the third outer canister 81, and being formed with a chamber and a plurality of holes in a manner that the chamber is used for storing a plurality of biological test pieces and the plural holes are formed at the bottom of the third inner container 82; and a plurality of desiccant granules 5, disposed inside the hollow compartment insulation 83 for allowing the same to absorb moisture and change color consequently; wherein, the third outer canister 81 is made of an opaque material and is formed with a transparent area 84 at the bottom of the outer canister at a position corresponding to the hollow compartment insulation 83, while the third inner canister 82 is made of a material selected from the group consisting of: an opaque material and a transparent material, and thereby, the color changing of the plural desiccant granules 5 inside the hollow compartment insulation 83 is observable.

To sum up, the present invention provides a desiccant container with moisture indicating ability, which is formed with at least one transparent area, to be used for allowing a plurality of desiccant granules stored inside the desiccant container to become observable, and thus, to determine whether the biological test pieced stored inside the desiccant container had already been exposed to moisture and become damp according to the color changing of the plural desiccant granules, Moreover, the desiccant granules in the present invention can be made of water glass, which is a soluble alkali-sodium silicate material and is characterized in that: it is blue in color when dry and will be turn into red after absorbing moisture.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

What is claimed is:

1. A desiccant container with moisture indicating ability, comprising:
an outer canister, formed with a cavity and having a cap connected thereto;
an inner canister, disposed inside the cavity of the outer canister while allowing a hollow compartment insulation to be formed between the bottom of the inner canister and the bottom of the outer canister, and being formed with a chamber and a plurality of holes in a manner that the chamber is used for storing a plurality of biological test pieces and the plural holes are formed at the bottom of the inner container; and
a plurality of desiccant granules, disposed inside the hollow compartment insulation for allowing the same to absorb moisture and change color consequently;
wherein, the outer canister is made of an opaque material while the inner canister is made of a transparent material, and thereby, the color changing of the plural desiccant granules inside the hollow compartment insulation is observable when the cap of the outer canister is opened.

2. The desiccant container with moisture indicating ability of claim 1, wherein the plural desiccant granules are made of water glass which is a soluble alkali-sodium silicate material.

3. A desiccant container with moisture indicating ability of claim 1, comprising:
an outer canister, formed with a cavity and having a cap connected thereto;
an inner canister, disposed inside the cavity of the outer canister while allowing a hollow compartment insulation to be formed between the bottom of the inner canister and the bottom of the outer canister, and being formed with a chamber and a plurality of holes in a manner that the chamber is used for storing a plurality of biological test pieces and the plural holes are formed at the bottom of the inner container; and
a plurality of desiccant granules, disposed inside the hollow compartment insulation for allowing the same to absorb moisture and change color consequently;
wherein, the outer canister is made of a transparent material while the inner canister is made of an opaque material, and thereby, the color changing of the plural desiccant granules inside the hollow compartment insulation is observable.

4. The desiccant container with moisture indicating ability of claim 3, wherein the plural desiccant granules are made of water glass which is a soluble alkali-sodium silicate material.

5. A desiccant container with moisture indicating ability of claim 1, comprising:
an outer canister, formed with a cavity and having a cap connected thereto;
an inner canister, disposed inside the cavity of the outer canister while allowing a hollow compartment insulation to be formed between the bottom of the inner canister and the bottom of the outer canister, and being formed with a chamber and a plurality of holes in a manner that the chamber is used for storing a plurality of biological test pieces and the plural holes are formed at the bottom of the inner container; and
a plurality of desiccant granules, disposed inside the hollow compartment insulation for allowing the same to absorb moisture and change color consequently;
wherein, the outer canister is made of an opaque material and is formed with a transparent area at the bottom of the outer canister at a position corresponding to the hollow compartment insulation, while the inner canister is made of a material selected from the group consisting of: an opaque material and a transparent material, and thereby, the color changing of the plural desiccant granules inside the hollow compartment insulation is observable.

6. The desiccant container with moisture indicating ability of claim 5, wherein the plural desiccant granules are made of water glass which is a soluble alkali-sodium silicate material.
